(19) United States
(12) Patent Application Publication
(10) Pub. No.: US 2019/0265651 A1
(43) Pub. Date: Aug. 29, 2019

(54) Timepiece Resonator

(71) Applicant: RICHEMONT INTERNATIONAL SA, Villars-Sur-Glâne (CH)

(72) Inventors: Stéphane Pommier, Delemont (CH); Frédéric Diologent, Neuchatel (CH)

(21) Appl. No.: 16/343,879

(22) PCT Filed: Nov. 6, 2017
(86) PCT No.: PCT/EP2017/078365

§ 371 Date: Apr. 22, 2019

(30) Foreign Application Priority Data
Nov. 4, 2016 (EP) 16306448.8

(51) Int. Cl. G04B 43/00; C22C 38/58; C22C 38/50; C22C 38/00; C22C 33/04; C21D 9/02; C21D 8/06; C21D 6/00; C21C 7/076; C21C 7/10; G04B 17/06

(52) U.S. Cl. CPC G04B 43/007; C22C 38/58; C22C 38/50; C22C 38/002; C22C 33/04; G04B 17/066; C21D 8/065; C21D 6/004; C21D 6/005; C21C 7/076; C21C 7/10; C21D 9/02

(57) ABSTRACT

An antiferromagnetic alloy consisting of: between 10.0 and 30.0 wt.-% manganese, •between 4.0 and 10.0 wt.-% chromium, •between 5.0 and 15.0 wt.-% nickel, •between 0.1 and 2.0 wt.-% titanium, •the remainder being iron and residual impurities, the alloy being free of beryllium.

### TECHNOLOGICAL FIELD

The present disclosure relates to an antiferromagnetic alloy based on iron and manganese as well as the preparation method thereof (alloying and transformation). The disclosure also relates to mechanical parts composed at least in part by this antiferromagnetic alloy.

The field of use of the disclosed embodiments relates to horology, in particular timepiece resonators.

### BACKGROUND

A timepiece resonator has the primary function of resonating in an invariable way regardless of the environment in which it is found. This is the reason why a resonator is preferably made from an elinvar material (constituted for example of 59% iron, 36% nickel and 5% chromium), that is to say that the Young's modulus (or elasticity) thereof remains insensitive to temperature variations (Charles-Edouard Guillaume, Nobel Prize for Physics, 1920). Documents EP 1 422 436 and EP 0 886 195 propose solutions providing materials which are, additionally, insensitive to magnetic fields. Generally, a resonator is manufactured from complex and costly alloys.

Historically, the most commonly used alloy is based on iron-nickel. Several additives have been incorporated into this base alloy to give the required mechanical resistance, corrosion resistance or even temperature variation or pressure variation resistance properties. Thus, alloys of which timepiece resonators are constituted generally comprise, in addition to iron and nickel, several additives such as chromium, silicon, titanium, manganese and beryllium. This alloy, known as Nivarox alloy, is an elinvar alloy having a Young's modulus insensitive to temperature changes. Further, the Young's modulus thereof varies very slightly under the considered temperatures (−15 to −50° C. in general) but much less than the majority of alloys (FIG. 1).

However, the manufacturing methods of these alloys are complex and the reproducibility thereof is limited, which may lead to modifications of the intrinsic mechanical properties of the alloys. The main problem with this alloy is that it is sensitive to magnetic fields. Yet, over recent years, the magnetic environment of watches has greatly changed with new technologies such as mobile phones, connected bracelets and laptops or the increase in the power and number of magnets in daily life (handbag clasps, door closing mechanisms or even metal detectors).

Furthermore, with the continuous evolution of regulations on chemical products, the majority of known alloys cannot or will no longer necessarily be able to be produced in the future. Indeed, a good number of them contain elements which are potentially harmful to health such as allergens or carcinogenic, mutagenic or reprotoxic agents. Thus, it would be very advantageous to develop a new alloy having all the mechanical, magnetic, corrosion-resistance, elinvar properties (Young's modulus insensitive to temperature change) and which are harmless to health to be used as a basic resonator material for timepieces.

One alternative to metallic alloys has been developed. This alternative consists of shaping silicon wafers, which inter alia makes the manufacturing process reproducible. However, notably in the case of a use as a balance spring, the mechanical behavior is not homogeneous along the axis of the movement (EP 1 422 436). Secondly, the current manufacturing methods limit the geometries of the resonator as well as correction operations by plastic deformation for example, such as the Phillips or Breguet balance spring.

The Applicant has developed a new antiferromagnetic alloy based on iron and manganese which overcomes the problems of the prior art. This alloy may be used as a material for the manufacture of a timepiece resonator. Indeed, this alloy has the required mechanical properties to be able to be shaped into a balance spring for example, which is not the case for all antiferromagnetic alloys (Liu et al., Acta Materialia, 2003, 51, 507-519). To do this, the alloy must be able to be drawn, rolled, wound and have suitable elastic properties.

### SUMMARY OF THE DISCLOSURE

The antiferromagnetic alloy is mainly constituted of iron and manganese. With regard to the composition and preparation method thereof, it offers a low-cost alternative, which is capable of being easily implemented relative to materials of the prior art.

Generally, the antiferromagnetic alloy is free of cobalt and beryllium.

This alloy has a hardness of between 200 Hv and 400 Hv, preferably between 280 Hv and 370 Hv, which is suitable for use in the horology field.

This alloy has a Young's modulus of between 150 GPa and 250 GPa, preferably between 160 GPa and 200 GPa, which is suitable for use in the horology field.

Thus, the disclosed embodiments also relate to a method of manufacturing this antiferromagnetic alloy and the use thereof in the field of horology, for example, to manufacture a timepiece resonator.

Alloy

According to a first embodiment, the antiferromagnetic alloy having a composition constituted of:
10.0% to 30.0% by weight manganese,
4.0% to 10.0% by weight chromium,
5.0% to 15.0% by weight nickel,
0.1% to 2.0% by weight titanium,
the remainder being iron and residual impurities.

The percentages are expressed by weight relative to the weight of the antiferromagnetic alloy.

This is an alloy of which the composition is homogeneous. The elements are therefore distributed homogeneously within the alloy.

This alloy is constituted of the elements above. In other words, it does not include other elements. Thus, this alloy is free of cobalt and beryllium.

The alloy is advantageously free from residual impurities. Thus, it advantageously comprises less than 1,500 ppm of residual impurities, relative to its weight, more advantageously less than 600 ppm.

The ppm are expressed by weight relative to the weight of the antiferromagnetic alloy.

The residual impurities may correspond to at least one of the following elements: silicon, carbon, sulfur, oxygen and nitrogen. In this alloy, the silicon concentration does not exceed 500 ppm. Further, the carbon, oxygen or sulfur concentration does not exceed 100 ppm. Finally, the nitrogen concentration does not exceed 20 ppm.

Advantageously, the manganese content is between 10% and 30% by weight, more advantageously between 24.0% and 26.0% by weight, even more advantageously between 24.0% and 24.6% by weight. The manganese content is high, since it is the association with the manganese that transforms the iron into an antiferromagnetic phase. There has to be enough of it for the iron no longer to be ferromagnetic. In contrast, it is not useful to exceed the optimum manganese concentration.

Advantageously, the chromium content is between 4.0% and 10.0% by weight, more advantageously between 6.5% and 9.0% by weight, and even more advantageously between 7.0% and 9.0% by weight, preferably between 7.3% and 8.1% by weight. The chromium forms a protective oxide layer upon contact with air (also known as passivation layer) which prevents premature corrosion of the material. Too small an amount of chromium will not enable the anticorrosive properties to be achieved.

Advantageously, the nickel content is between 5.0% and 15.0% by weight, more advantageously between 5.5% and 7.5% by weight, preferably between 6.3% and 6.6% by weight. The nickel serves to stabilize the antimagnetic iron-manganese phase, which without it is only stable at temperatures greater than ambient temperature.

According to another embodiment, the titanium content is advantageously between 0.5% and 2.0% by weight, more advantageously between 0.3% and 1.3% by weight, and even more advantageously between 0.3% and 1.2% by weight, preferably between 0.5% and 0.8% by weight. The titanium is a hardener, it serves to obtain the mechanical properties necessary for the transformation process of the material. In contrast, its affinity with oxygen and nitrogen makes it an impurity pump. In other words, the presence of titanium also promotes the presence of impurities. This is why the content thereof is limited.

According to a particular embodiment, the antiferromagnetic alloy is constituted of:
24.0% to 26.0% by weight manganese,
7.0% to 9.0% by weight chromium,
5.5% to 7.5% by weight nickel,
0.3% to 1.2% by weight titanium,
the alloy being free of beryllium,
the remainder being iron and residual impurities.

According to a particular embodiment, the antiferromagnetic alloy is constituted of:
24.0% to 24.6% by weight manganese,
7.3% to 8.1% by weight chromium,
6.3% to 6.6% by weight nickel,
0.5% to 0.8% by weight titanium,
the alloy being free of beryllium,
the remainder being iron and residual impurities.

The amount of iron is adjusted depending on the embodiments and corresponds to the amount necessary to reach 100% by weight. As already indicated, the amount of impurities is advantageously lower than 1,500 ppm.

Use of the Alloy

Advantageously, the antiferromagnetic alloy is used in the field of horology, notably for manufacturing a timekeeping movement component.

Also, the present disclosure equally relates to a timekeeping movement component at least partially constituted by this antiferromagnetic alloy. It is advantageously entirely constituted by this alloy.

According to another particular embodiment, the timekeeping movement component is a resonator, at least partially constituted by this antiferromagnetic alloy. Advantageously, the resonator is entirely constituted by the antiferromagnetic alloy.

According to another particular embodiment, the resonator is in the form of a balance spring, but it may also be a flexible strip resonator, like a tuning fork, or a virtual pivot type, using the principle of flexible guidance.

The disclosed embodiments also relate to a timekeeping movement comprising at least one of the components constituted at least partially by this antiferromagnetic alloy.

The disclosure also relates to a watch comprising a timekeeping movement of which at least one of the components comprises this antiferromagnetic alloy.

This watch comprises at least one component at least partially constituted by the antiferromagnetic alloy. Preferably, the component is a resonator and more preferably, the component is a balance spring entirely constituted by the alloy.

Manufacturing and forming method of the antiferromagnetic alloy

The manufacturing method of the antiferromagnetic alloy has at least one melt and one purification step. The melt enables the alloy to be formed with the desired metals. The second melt enables the alloy to be purified by the removal of as many impurities as possible. Particular attention is paid to manganese, the partial pressure of the gas of which is relatively high at alloy melting temperatures. Advantageously, the method enables the same quantity of manganese to be maintained before and after a melt and purification step.

Said method for manufacturing an alloy comprising iron and manganese notably comprises the following successive steps:
a step of melting the constituents of the alloy, carried out in one or more phase(s), enabling the alloy containing the desired metals to be formed, and carried out at a temperature Tₘₑₗₜ equal to or greater than the melting point of the constituents of the alloy, the constituents of the alloy being at least based on iron and based on manganese,
a purification step, carried out in one or more phase(s), enabling the impurities from the constituents of the alloy to be removed while limiting the evaporation of manganese, and carried out at a temperature Tₚᵤᵣ and a pressure P greater than atmospheric pressure.

Advantageously, at the end of the purification step, the alloy has a total impurities content less than or equal to 1,500 ppm. The impurities are those mentioned above.

The purification step at pressure P is carried out in a way so as to limit the evaporation of manganese. Thus, advantageously, the variation in the manganese content resulting from the purification step carried out at the temperature Tₚᵤᵣ and under pressure P does not exceed 5%. In other words, a variation in the manganese advantageously less than or equal to 5% by weight, relative to the quantity of manganese resulting from the melting step, results from the purification step.

Thus, the manufacturing method of the antiferromagnetic alloy has at least the following successive steps:
a) a step of melting the constituents of the alloy enabling the alloy to be formed with the desired metals; this step may be for example carried out in an arc furnace (notably an electric arc furnace) or a vacuum induction melting furnace (VIM),
b) a melting of the alloy obtained in step a) enabling the alloy to be purified while limiting the variation in the manganese content, notably by limiting the evaporation thereof by carrying out this step at a pressure greater than atmospheric pressure. Without being limited to these techniques, this step may for example be carried out by a technique selected from pressure electro slag remelting (PESR) or cold crucible melting to enable dissolution of the impurities and inclusions. The purification step is thus carried out by a method involving a remelt at a pressure greater than atmospheric pressure, advantageously a pressure electro slag remelting process at a pressure greater than atmospheric pressure.

Advantageously, the temperature Tₚᵤᵣ is between 1250 and 1450° C., more advantageously between 1300 and 1400° C.

Further, the temperature Tₘₑₗₜ of the step of melting the constituents of the alloy is advantageously between 1250° C. and 1450° C., more advantageously between 1300° C. and 1400° C.

For the purification step, it is important to note that the manganese tends to evaporate quite quickly above a certain temperature. With the final manganese content in the alloy being very important for obtaining certain properties of the material, it is important to use a method limiting its evaporation. While the evaporation depends, beyond a certain temperature, on the exposure pressure of the material to the process, a step carried out under pressure substantially reduces the variation in the manganese content.

The purification step carried out at a temperature Tₚᵤᵣ according to the previously stated range is advantageously carried out at a pressure P greater than 10 bar, more advantageously greater than 20 bar, and even more advantageously greater than 40 bar. Pressure P is advantageously lower than or equal to 50 bar.

In contrast, the melting step is not necessarily carried out at a pressure greater than atmospheric pressure. It may notably be carried out under vacuum for example, in a vacuum induction furnace.

In order to use this alloy in the horology field, it is processed according to conventional techniques. It is to be noted that the method described above may also be applied, without departing from the scope of the disclosure, to any alloy comprising the elements iron and manganese, notably to any alloy in which the manganese content must be controlled.

Thus, in a general manner, to form a balance spring, an ingot of the antiferromagnetic alloy is hot-forged. Forging of the ingot is carried out at a temperature lower than the melting point of the alloy, preferably lower than or equal to 1100° C. However, the forging temperature is advantageously greater than 800° C. Forging enables bars having a diameter preferably between 10 mm and 40 mm, more preferably between 15 mm and 25 mm to be obtained.

The bars obtained by hot forging are then hot-rolled, then cold-rolled to a diameter of 5 mm.

Advantageously, the rolling is carried out after a thermal treatment at a temperature preferably between 1200° C. and 800° C., more preferably between 1100° C. and 900° C. to decrease its hardness.

Advantageously, the bars having a diameter of 5 mm are then cold-drawn to the required diameter, advantageously in the order of 0.5 mm. During drawing, one or more thermal treatments may be implemented. These thermal treatments are implemented at a temperature advantageously between 800° C. and 1200° C., more advantageously between 900° C. and 1100° C.

The alloy may then be drawn to a final diameter advantageously of less than 100 μm then rolled, coiled and fixed to form a balance spring.

The contemplated embodiments and the advantages deriving therefrom will be better understood from the following figures and examples in order to provide a non-limiting illustration.

### BRIEF DESCRIPTION OF THE FIGURES

FIG. 1 shows the Young's modulus of the Nivarox alloy (38 to 41% nickel, 7.8 to 8% chromium, 1% titanium, 0.2% silicon, 0.4% manganese, 0.8 to 0.9% beryllium, and the remainder iron) as a function of temperature.

FIG. 2 illustrates the magnetic hysteresis cycle of the same Nivarox alloy.

FIG. 3 illustrates the evolution of the Young's modulus of an alloy as a function of temperature, after different thermal treatments.

FIGS. 4 to 15 illustrate the magnetic hysteresis cycles of an alloy as a function of temperature and thermal treatment time.

FIG. 16 corresponds to a simulation of the distribution diagram of the different phases of an alloy as a function of temperature.

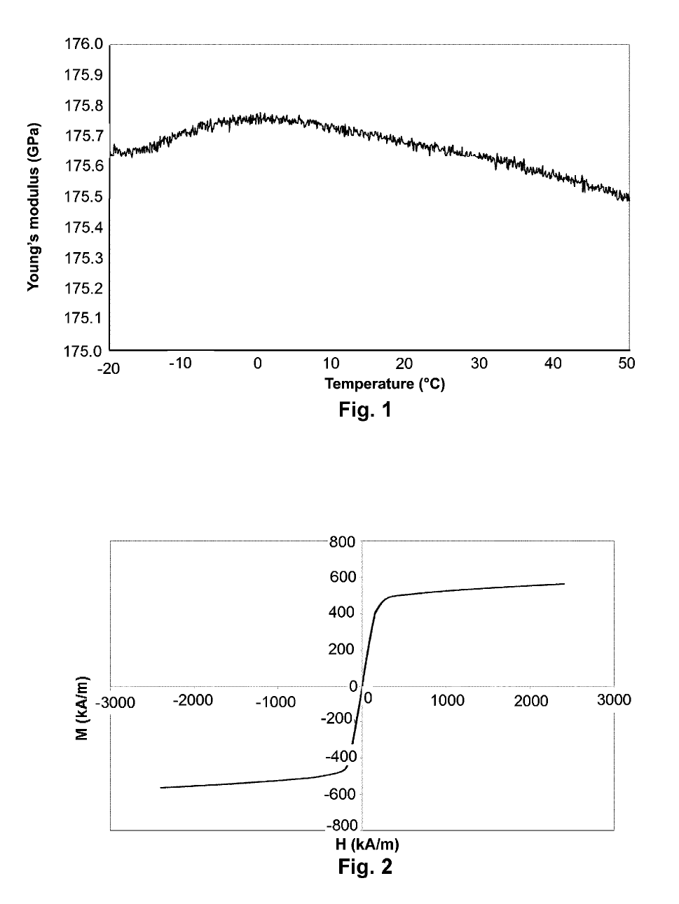

### DETAILED DESCRIPTION

Several examples of alloys have been made according to the described embodiments. (INV-1 to INV-12) have been prepared according to the following steps:
melting constituents of the alloy,
purification of the alloy,
obtaining the alloy,
mechanical treatment (preferably forging, but applicable also to drawing) and thermal treatment of the alloy.

Experimental conditions of the thermal treatment (carried out after the purification step) are specified in Table 1.

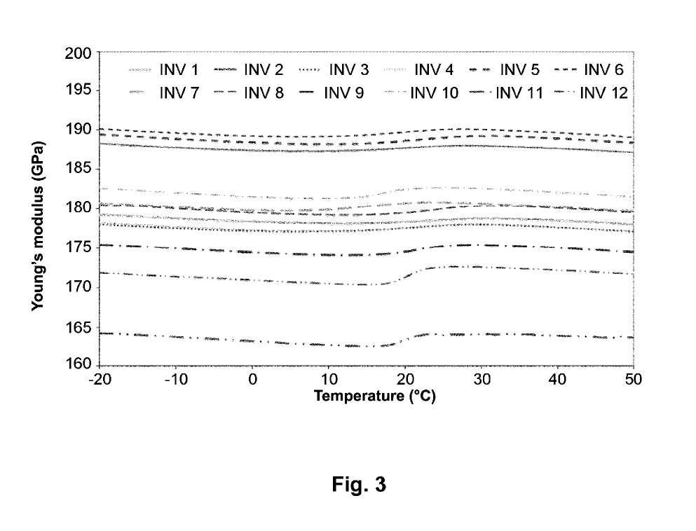

TABLE 1
preparation conditions of the alloys INV-1 to INV-12.

| | INV-1 | | INV-2 | | INV-3 | | INV-4 | | INV-5 | | INV-6 | |
|---|---|---|---|---|---|---|---|---|---|---|---|---|
| Conditions: | (FIGS. 3 | | (FIGS. 3 | | (FIGS. 3 | | (FIGS. 3 | | (FIGS. 3 | | (FIGS. 3 | |
| | and 4) | | and 5) | | and 6) | | and 7) | | and 8) | | and 9) | |
| time | 30 | min | 60 | min | 30 | min | 60 | min | 30 | min | 60 | min |
| Fixing | 500° | C. | 500° | C. | 550° | C. | 550° | C. | 600° | C. | 600° | C. |
| temperature | | | | | | | | | | | | |
| | INV-7 | | INV-8 | | INV-9 | | INV-10 | | INV-11 | | INV-12 | |
| Conditions: | (FIGS. 3 | | (FIGS. 3 | | (FIGS. 3 | | (FIGS. 3 | | (FIGS. 3 | | (FIGS. 3 | |
| | and 10) | | and 11) | | and 12) | | and 13) | | and 14) | | and 15) | |
| time | 30 | min | 60 | min | 30 | min | 60 | min | 30 | min | 60 | min |
| Fixing | 650° | C. | 650° | C. | 700° | C. | 700° | C. | 780° | C. | 780° | C. |
| temperature | | | | | | | | | | | | |

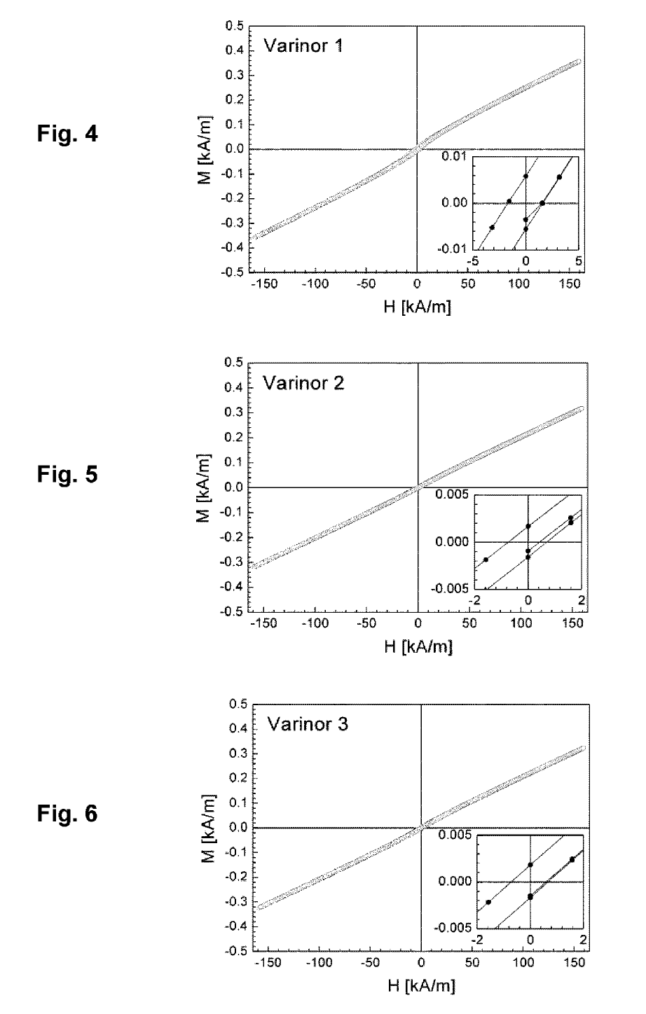

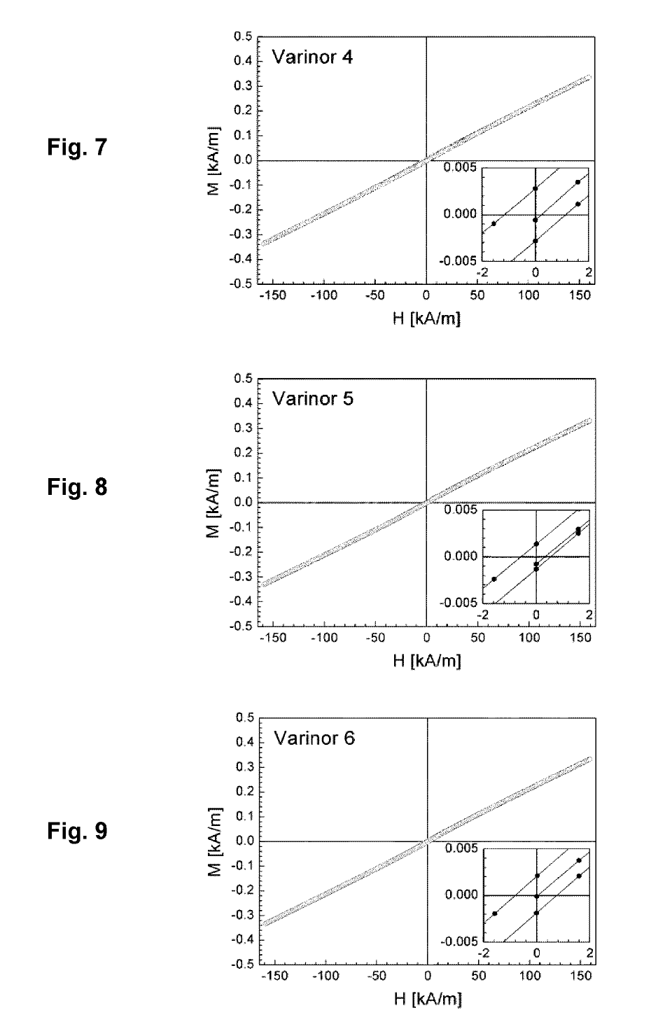

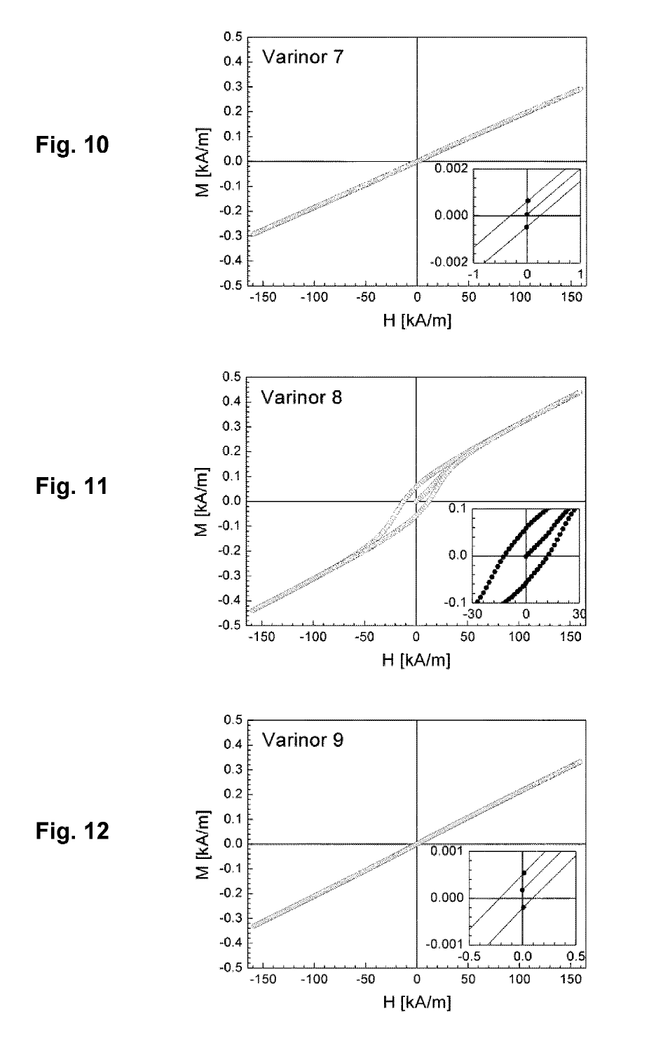

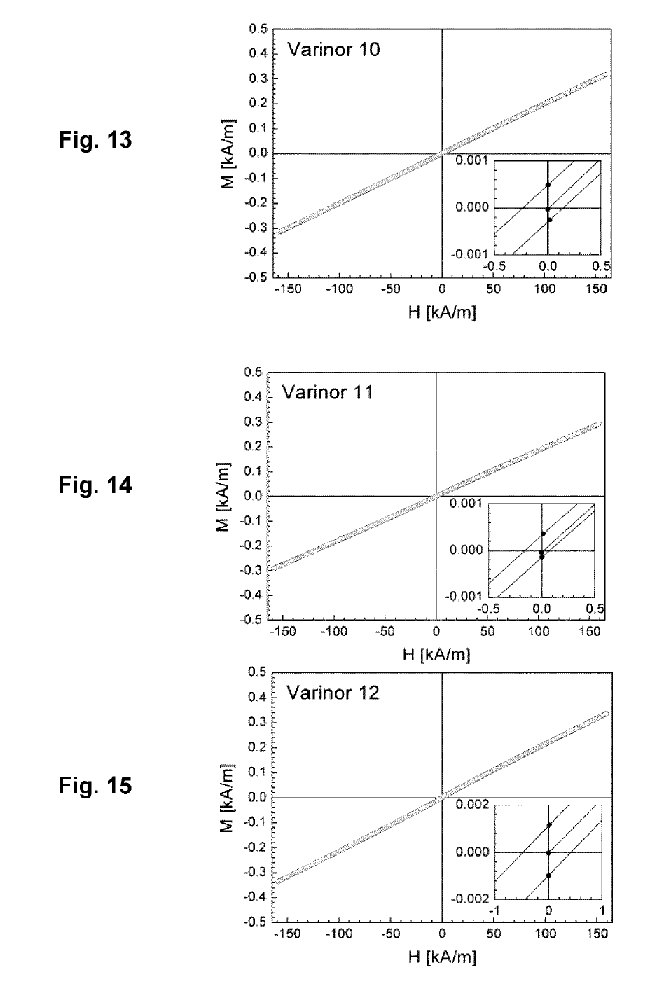

FIGS. 4 to 15 illustrate the magnetic hysteresis cycles of the alloys according to examples INV-1 to INV-12. These alloys have the same composition, but they have been subjected to different treatments. FIGS. 4 to 15 therefore reflect the magnetic hysteresis cycles as a function of temperature and thermal treatment time. The influence of these two annealing factors is visible on the magnetic measurements (FIGS. 4 to 15). We can also see the influence of temperature and time on the evolution of the anomaly in the behavior of the measurement of the Young's modulus as a function of temperature (FIG. 3).

Magnetic measurements have been carried out on the examples INV-1 to INV-12. The mass and density measured as well as the sample volume are given in Table 2.

TABLE 2
mass, density and volume of samples.

| Examples | Mass (mg) | Density (g/cm³) | Volume (cm³) |
|---|---|---|---|
| INV-1 | 5.55 | 7.977 | 6.9575 · 10⁻⁴ |
| INV-2 | 5.95 | 8.00725 | 7.43077 · 10⁻⁴ |
| INV-3 | 3.87 | 7.8399 | 4.93629 · 10⁻⁴ |
| INV-4 | 2.78 | 7.9478 | 3.49782 · 10⁻⁴ |
| INV-5 | 2.71 | 8.0159 | 3.38078 · 10⁻⁴ |
| INV-6 | 6.14 | 8.003 | 7.67212 · 10⁻⁴ |
| INV-7 | 5.55 | 8.0059 | 6.93239 · 10⁻⁴ |
| INV-8 | 2.99 | 7.9704 | 3.75138 · 10⁻⁴ |
| INV-9 | 3.23 | 7.9798 | 4.04772 · 10⁻⁴ |
| INV-10 | 5.78 | 7.9574 | 7.26368 · 10⁻⁴ |
| INV-11 | 6.29 | 7.9319 | 7.93 · 10⁻⁴ |
| INV-12 | 6.72 | 7.9897 | 8.41083 · 10⁻⁴ |

The measurement of the magnetic moment as a function of the applied magnetic field has been carried out in VSM mode (vibrating sample) with a frequency of 14 Hz and an amplitude of 3 mm.

The magnetic hysteresis cycles were measured over five quadrants (FIGS. 4 to 15), going from a minimum field of −2000 Oe (˜−159 kA/m) to a maximum field of +2000 Oe (˜+159 kA/m), with a path of 20 Oe (˜1592 A/m).

The coercive field, residual field, saturated magnetization values are summarized in Table 3.

TABLE 3
properties of the samples

| | Coercive | Residual | Saturated | Susceptibility |
|---|---|---|---|---|
| | field | magnetization | magnetization | dM/dH |
| Examples | (kA/m) | (A/m) | (kA/m) | at M = 0 |
| INV-1 | 1.66 | 5.8 | non-saturated | 0.00317 |
| INV-2 | 0.73 | 1.7 | non-saturated | 0.00216 |
| INV-3 | 0.70 | 1.8 | non-saturated | 0.00228 |
| INV-4 | 1.17 | 2.8 | non-saturated | 0.00224 |
| INV-5 | 0.56 | 1.4 | non-saturated | 0.00225 |
| INV-6 | 0.78 | 2.1 | non-saturated | 0.00226 |
| INV-7 | 0.25 | 0.6 | non-saturated | 0.00190 |
| INV-8 | 1.25 | 5.9 | non-saturated | 0.00429 |
| INV-9 | 0.10 | 0.5 | non-saturated | 0.00216 |
| INV-10 | 0.16 | 0.5 | non-saturated | 0.00203 |
| INV-11 | 0.10 | 0.34 | non-saturated | 0.00191 |
| INV-12 | 0.48 | 1.2 | non-saturated | 0.00223 |

We see that the thermal treatments enable the residual magnetism to be clearly reduced. We can thus select the optimal thermal treatment for this specific alloy. A measurement at higher field (2T) has been carried out in order to find any saturation, but the linear behavior of M(H) is retained, indicating that the field saturation is probably located beyond the limits of this system.

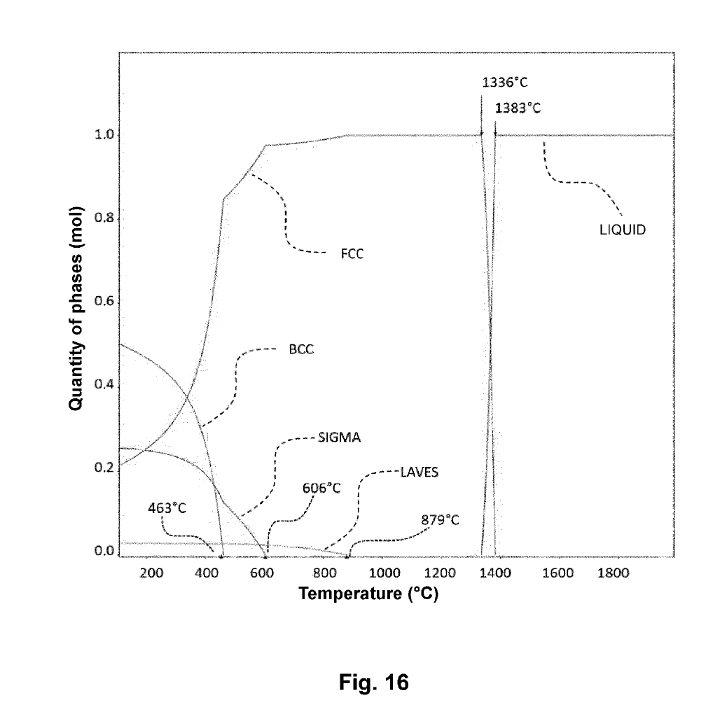

FIG. 16 corresponds to a simulation illustrating the different phases of this alloy as a function of temperature, and more particularly the proportion of sigma phases (intermetallic phase), Laves phase, BCC (body centered cubic) and FCC (face centered cubic) structures, and liquid phase. This diagram also shows the solidification 1336° C.) and liquefaction or melting (1383° C.) temperatures of the alloy.

1. An antiferromagnetic alloy having a composition constituted of:
10.0% to 30.0% by weight manganese,
4.0% to 10.0% by weight chromium,
5.0% to 15.0% by weight nickel,
0.1% to 2.0% by weight titanium,
the remainder being iron and residual impurities,
the alloy being free of beryllium.

2. The alloy according to claim 1, wherein the manganese content is between 24% and 26% by weight.

3. The alloy according to claim 1, wherein the chromium content is between 7% and 9% by weight.

4. The alloy according to claim 1, wherein the nickel content is between 5.5% and 7.5% by weight.

5. The alloy according to claim 1, wherein the titanium content is between 0.3% and 1.2% by weight.

6. A timekeeping movement component at least partially constituted of an alloy according to claim 1.

7. The component according to claim 6, wherein the component is a resonator.

8. The component according to claim 6, wherein the component is a resonator in the form of a balance spring, or a flexible strip resonator, or a virtual pivot resonator.

9. A timekeeping movement component comprising at least one component according to claim 6.

10. A watch comprising a timekeeping movement according to claim 9.

11. A method for preparing an alloy according to claim 1, comprising the following successive steps:
a step of melting the constituents of the alloy, carried out in one or more phases and at a temperature Tₘₑₗₜ, enabling the alloy containing the desired metals to be formed,
a purification step, carried out in one or more phase(s), enabling the impurities from the constituents of the alloy to be removed while limiting the evaporation of manganese, and carried out at a temperature Tₚᵤᵣ and a pressure P greater than atmospheric pressure.

12. The method according to claim 11, wherein, at the end of the purification step, the alloy has a total impurities content of less than or equal to 1,500 ppm.

13. The method according to claim 11, wherein the purification step results in a variation in the manganese of less than or equal to 5% by weight, relative to the quantity of manganese resulting from the melting step.

14. The method according to claim 11, wherein the temperature Tₚᵤᵣ of the purification step is between 1250° C. and 1450° C., advantageously between 1300° C. and 1400° C., and in that the temperature Tₘₑₗₜ of the step of melting the constituents of the alloy is between 1250° C. and 1450° C., advantageously between 1300° C. and 1400° C.

15. The method according to claim 11, wherein the purification step is carried out at a pressure P greater than 10 bar, advantageously greater than 20 bar, the pressure P being advantageously lower than or equal to 50 bar.

16. The method according to claim 15, wherein the method of the purification step is an electro conducting slag pressure method.
